(19) United States
(12) Patent Application Publication
(10) Pub. No.: US 2018/0081026 A1
(43) Pub. Date: Mar. 22, 2018

(54) LAST MILE POSITIONING OF A MOBILE COMMUNICATION DEVICE

(71) Applicant: SEPTIER COMMUNICATION LTD., Petach Tikva (IL)

(72) Inventors: Yaron BARATZ, Herzliya (IL); Uri SAVORA, Rehovot (IL); Nir FISHER, Hod-Hasharon (IL)

(21) Appl. No.: 15/569,390

(22) PCT Filed: Apr. 3, 2016
(86) PCT No.: PCT/IL2016/050357

§ 371 Date: Oct. 26, 2017

Related U.S. Application Data
(60) Provisional application No. 62/154,140, filed on Apr. 29, 2015.

(51) Int. Cl. G01S 5/12; H04W 4/02

(52) U.S. Cl. CPC G01S 5/12; H04W 84/042; H04W 4/02

(57) ABSTRACT

A method for enabling last mile positioning of a target mobile communication device that is configured to communicate via a mobile communication network includes communicating with the target mobile communication device via the mobile communication network to cause the target mobile communication device to transmit a signal. At least one parameter of the transmitted signal is sent to one or a plurality of direction finder devices to enable the one or a plurality of direction finder devices to receive and distinguish the transmitted signal. Geographic information related to the last mile positioning of the target mobile communication device is received from the direction finder devices.

### FIELD OF THE INVENTION

The present invention relates to mobile communication devices. More particularly, the present invention relates to last mile positioning of a mobile communication device.

### BACKGROUND OF THE INVENTION

In the course of emergency response or law enforcement operations, it is sometimes necessary to determine the exact position of a mobile communication device in order to reach the device. For example, when an emergency service is called from a landline telephone, the address of that telephone may be immediately available to an emergency dispatcher. Even when the call is made from a building with a large number of apartments, rooms, or offices, the address may be sufficiently precise (e.g., including an apartment, room, or office number), or a telephone exchange may be so configured, so as to enable sending emergency personnel to the correct location in a timely manner.

In most of the world, use of cellular communication devices has increased dramatically and is expected to further grow in the coming years. For some users, use of a cellular communications has completely replaced landline telephone use. Thus, an increasing number of emergency calls are made from cellular communication devices. In some cases, the person making the emergency call is not sufficiently familiar with the area in order to direct an emergency responder to the precise location of the reported emergency. In other cases, the person making the call may be ill, under threat, or otherwise may not have the ability or the time to be able to report the exact location. Thus, it is important to be able to obtain a precise location of the cellular communication device.

Other situations may require precise determination of a location of a cellular communication device. For example, law enforcement or rescue personnel may require a location or a cellular communication device in order to be able to physically find a suspect or a missing person who is the user, owner or the person carrying the cellular communication device.

Although certain network elements in a cellular network may be able to provide an approximate location of a cellular telephone (e.g., may indicate in which cell of the network the cellular telephone is currently located), more precise (“last mile”) determination of the location typically requires use of auxiliary locator equipment. For example, a search or rescue team that arrives in the general vicinity may require use of a mobile detector to detect signals that are emitted by the cellular telephone in order to home in on the signal and physically reach the device or its immediate vicinity.

### SUMMARY OF THE INVENTION

There is thus provided, in accordance with an embodiment of the present invention, a method for enabling last mile positioning of a target mobile communication device that is configured to communicate via a mobile communication network, the method including: communicating with the target mobile communication device via the mobile communication network to cause the target mobile communication device to transmit a signal; and sending at least one parameter of the transmitted signal to one or a plurality of direction finder devices to enable the one or a plurality of direction finder devices to receive and distinguish the transmitted signal.

Furthermore, in accordance with an embodiment of the present invention, the method includes receiving an identification of the target mobile communication device.

Furthermore, in accordance with an embodiment of the present invention, the method includes receiving the at least one parameter from the mobile communication network.

Furthermore, in accordance with an embodiment of the present invention, receiving the at least one parameter includes communicating with an operations support system (OSS), base station controller (BSC), or radio network controller (RNC) of the mobile communication network, the mobile communication network being a cellular network.

Furthermore, in accordance with an embodiment of the present invention, the target mobile communication device includes a cellular telephone, and wherein the mobile communication network includes a cellular network.

Furthermore, in accordance with an embodiment of the present invention, the at least one parameter is selected from the group of parameters consisting of frequency, timeslot and sub-timeslot.

Furthermore, in accordance with an embodiment of the present invention, the method includes receiving from said one or a plurality of direction finder devices geographic information related to the last mile positioning of the target mobile communication device.

Furthermore, in accordance with an embodiment of the present invention, the geographic information is selected from a group consisting of a position of a direction finder device of the one or a plurality of direction finder devices, a direction toward the target mobile communication device from a direction finder device of the one or a plurality of direction finder devices, a distance of the target mobile communication device from a direction finder device of the one or a plurality of direction finder devices, and a position of the target mobile communication device.

Furthermore, in accordance with an embodiment of the present invention, the method includes outputting a position of the target mobile communication device or of a direction finder device of the one or a plurality of direction finder devices.

Furthermore, in accordance with an embodiment of the present invention, the method includes receiving a command to communicate with the target mobile communication device to cause the target mobile communication device to begin the transmitting of the signal or to terminate the transmitting of the signal.

There is further provided, in accordance with an embodiment of the present invention, a system for enabling last mile positioning of a target mobile communication device that is configured to communicate via a mobile communication network, the system including: a network communications link to the mobile communication network; a finder communications link to one or a plurality of direction finder devices, each of the one or a plurality of direction finder devices configured to receive a signal and to generate information to enable last mile positioning of a source of the received signal; and a processor that is configured to operate in accordance with programmed instructions to: communicate with the target mobile communication device via the network communications link and the mobile communication network to cause the target mobile communication device to transmit a signal that is receivable by the one or a plurality of direction finder devices; and send via the finder communications link at least one parameter of the transmitted signal to the one or a plurality of direction finder devices to enable the one or a plurality of direction finder devices to receive and distinguish the transmitted signal.

Furthermore, in accordance with an embodiment of the present invention, the processor is further configured to communicate with an input device to receive an identification of the target mobile communication device.

Furthermore, in accordance with an embodiment of the present invention, the processor is further configured to receive the at least one parameter from the mobile communication network.

Furthermore, in accordance with an embodiment of the present invention, the processor is further configured to communicate with an input device to receive a command to communicate with the target mobile communication device to cause the target mobile communication device to begin the transmitting of the signal or to terminate the transmitting of the signal.

Furthermore, in accordance with an embodiment of the present invention, the processor is further configured to communicate with the mobile communication network via the network communications link to receive the at least one parameter.

Furthermore, in accordance with an embodiment of the present invention, the processor is configured to communicate with an OSS, BSC or RNC of the mobile communication network to receive the at least one parameter.

Furthermore, in accordance with an embodiment of the present invention, the target mobile communication device includes a cellular telephone, and wherein the mobile communication network includes a cellular network.

Furthermore, in accordance with an embodiment of the present invention, the at least one parameter is selected from the group of parameters consisting of frequency, timeslot and sub-timeslot.

Furthermore, in accordance with an embodiment of the present invention, the processor is configured to receive from the one or a plurality of direction finder devices geographic information that is generated by said one or a plurality of direction finder devices.

Furthermore, in accordance with an embodiment of the present invention, the geographic information is selected from a group consisting of a position of a direction finder device of said one or a plurality of direction finder devices, a direction toward the target mobile communication device from a direction finder device of said one or a plurality of direction finder devices, a distance of the target mobile communication device from a direction finder device of said one or a plurality of direction finder devices, and a position of the target mobile communication device.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a system to enable last mile positioning of a mobile communication device, in accordance with an embodiment of the present invention.

FIG. 2 is a diagram of an example of data flow during operation of a system to enable last mile positioning of a mobile communication device, in accordance with an embodiment of the present invention.

FIG. 3 is a flowchart depicting a method for last mile positioning of a mobile communication device, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the present invention, a mobile communication device location enablement system is configured to enable a field team to reach a target mobile communication device by homing in on the device (“last mile positioning”). A mobile communication device may include a cellular telephone, smartphone, portable computer, or other device that is capable of connecting to and communicating via a mobile communication network, such as a cellular network or similar network (e.g., interlinked Wi-Fi routers or another network via which mobile communication devices may communicate with one another or with a server). As used herein, last mile positioning refers to enabling physically reaching a target mobile communication device (and, in some cases, a person carrying the target mobile communication device). Last mile positioning is typically accomplished by homing in on a signal that is emitted by the target mobile communication device. Last mile positioning is achieved when visual or other physical contact (e.g., aural, tactile, or other physical contact) is established with the target mobile communication device (or with a person, vehicle, or other object that is carrying or connected to the device), or when a location of the target mobile communication device is determined with sufficient precision to enable such physical contact with the target mobile communication device.

The mobile communication device location enablement system interacts with the mobile communication network. For example, a mobile communication device may include a cellular telephone that communicates via a cellular network. In response to the interaction, the target mobile communication device is caused to transmit signals that are detectable by a direction finder device. The transmission of a signal by the target mobile communication device may be configured such that transmission of the signal is not discernable by a user of the device. For example, the transmitted signal may include a signal that is routinely and/or continuously transmitted by a mobile communication device that communicates via the mobile communication network. Such transmission of signals in response to, or that is utilized by, operation of the mobile communication device location enablement system is herein referred to as a silent transmission session (STS).

The mobile communication device location enablement system may receive identifying information regarding a target mobile communication device that is to be located. The mobile communication device location enablement system may interact with a database of mobile communication devices to determine various parameters or other information required to establish communication with the target mobile communication device. For example, the information may include a mobile communication network operator via which the target mobile communication device communicates. If the mobile communication network operator is one with which the mobile communication device location enablement system cooperates, the mobile communication device location enablement system may establish communication with the target mobile communication device via the appropriate mobile communication network. The mobile communication device location enablement system may then, via the mobile communication network, instruct the mobile communication device to transmit an STS signal.

Once the STS has been initiated, the mobile communication device location enablement system may transmit information regarding the STS signal to one or more direction finder devices. The mobile communication network may limit the location of the mobile communication device to an identified geographic region. For example, the geographic region may coincide with a region that is covered by a particular cell, or two or more neighboring cells, of a cellular telephone network. The information may then be transmitted to one or more direction finder devices that are associated with the mobile communication device location enablement system and that are currently in or near the identified geographical region.

The mobile communication device location enablement system may furthermore transmit to the direction finder devices information that enables the direction finder device to distinguish the STS signal from any other detected signals. For example, the information may include RF parameters of the signal. When appropriate information is available from the mobile communication network, the information may include parameters that enable identifying the STS signal. The nature of the parameters may vary from network to network or from one STS signal to another, depending on the technology, protocols, or other variable characteristics of the interaction of the mobile communication device with the mobile communication network. For example, in some cases the information may include a transmission frequency, an assigned time slot, a sub-time slot, or other parameters.

A direction finder device may be a mobile communication device (e.g., portable or vehicle mountable device) that may be operated by a field team (e.g., a search or rescue team) that is looking for a person who is associated with (e.g., owner or user of) the target mobile communication device. The direction finder device may be configured to detect the STS signal and discriminate the STS signals from other detected signals. For example, the direction finder device may utilize identification data and other parameters of the STS signal that were transmitted to direction finder device by the mobile communication device location enablement system. The direction finder device may analyze the detected STS signal to determine a direction toward the mobile communication device that is transmitting the signal, and, in some cases, at least an approximate distance to the mobile communication device based on various parameters such as the received signal strength indication (RSSI). The analysis results may be transmitted to the mobile communication device location enablement system. Thus, an operator of the mobile communication device location enablement system may monitor the progress of the field team, and possibly report the information to additional teams (e.g., one team may be tasked with locating the target mobile communication device while another team is tasked with providing emergency assistance). Alternatively or in addition, the direction finder device may transmit characteristics of the detected STS signal to the mobile communication device location enablement system for analysis. Results of the analysis may be transmitted to the direction finder device, or to another device (e.g., a portable computing device) that is associated with the direction finder device or with the field team. Thus, the field team that is operating the direction finder device may be enabled to move toward the mobile communication device.

A mobile communication device location enablement system, in accordance with an embodiment of the present invention, may be advantageous over other systems or techniques for last mile positioning of a mobile communication device. For example, with such other techniques, a field team uses a cell emulation device that emulates a cell of the mobile communication network. The cell emulation device could induce the mobile communication device to interact with the cell emulation device as it would with a cell by transmitting a signal. Since there would be no direct contact with the mobile communication network, the direction finder device could require a capability to scan over radiofrequency signals to detect the signal that is emitted by the target mobile communication device. The cell emulation device could require reconfiguring for each type of mobile communication network or target device (or separate cell emulation devices). The cell emulation device could interfere with radiofrequency transmissions by other devices, and its use could entail unauthorized use of a spectral band that is assigned to the mobile communication network. Since the cell emulation device is a standalone device, the cell emulation device could be subject to misuse by a user with access to the device. Depending on the type of signal and cellular technology (e.g., 3G technology), detecting, distinguishing, and maintaining acquisition of the signal could be difficult and time consuming, and thus could delay provision of any needed emergency assistance or other time sensitive operations. Use of the emulation device could be detectable or jammable by an appropriate, and in some cases, readily available, detector or countermeasures device (e.g., by a suspected criminal who wishes to avoid detection by a law enforcement agency). Following the target device could be frustrated by movement of the target device (e.g., into another cell of the mobile communication network) or change of mode of the device (e.g., initiating a telephone conversation).

On the other hand, a mobile communication device location enablement system, in accordance with an embodiment of the present invention, cooperates with the mobile communication network, and utilizes resources of the cellular, in order to cause the mobile communication device to transmit. Therefore, only the direction finder device need be carried by the field team. Cooperation with the mobile communication network may provide sufficient information to enable immediate identification of the STS signal by the direction finder device. Contact with the target mobile communication device may be maintained under all circumstances (e.g., except where supply of electric power to the target mobile communication device is completely interrupted, e.g., by depletion or removal of a battery, or, in some cases, by turning off power to the target mobile communication device).

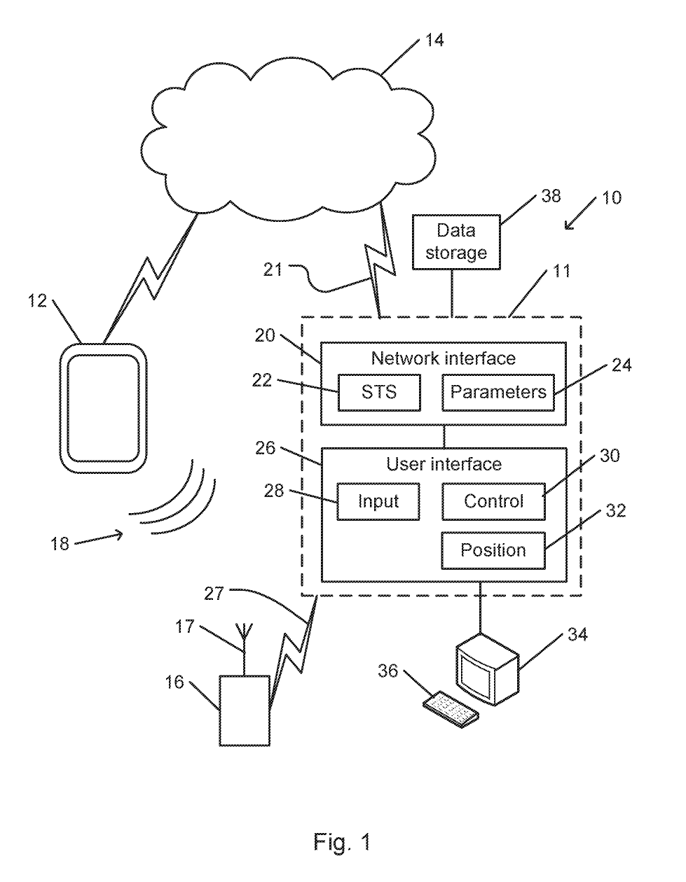

FIG. 1 schematically illustrates a system to enable last mile positioning of a mobile communication device, in accordance with an embodiment of the present invention.

Mobile communication device location enablement system 10 includes processor 11. For example, processor 11 may include one or more intercommunicating processing units, e.g. of one or more computers. Some or all of the processor units of processor 11 may be located at locations that are remote from one another. Some or all of the processing units of processor 11 may be dedicated to one or more functionalities of processor 11.

Processor 11 may communicate with data storage 38. Data storage 38 may include one or more volatile or nonvolatile, fixed or removable, local or remote, memory devices or data storage units. In some cases data storage 38 may include one or more databases or sources of data that are remotely accessible via one or more communications networks, such as the Internet, a mobile telephone network, or other network that is accessible via wired or wireless communication. Data storage 38 may be utilized to store, for example, programmed instructions for operation of processor 11, data or parameters for use by processor 11 during operation, or results of operation of processor 11. Data storage 38 may include a computer readable medium that includes instructions for installation of programmed instructions for operation of processor 11.

In particular, processor 11 may be configured to operate in accordance with programmed instructions to execute operations that are classified, for convenience, as being associated with one or more execution modules or sub-modules. For example, operations that are executed by processor may be considered to be broadly classified as being associated with one or more of user interface module 26 or network interface module 20. In some cases, different processing units of processor 11 may be configured to execute operations of user interface module 26 and of network interface module 20. For example, in some cases, operations of user interface module 26 may be executed on a processing unit of processor 11 that is associated with a command, control, and communications center of mobile communication device location enablement system 10. Operations of network interface module 20 may be executed on a processing unit of processor 11 that is associated with a mobile communication network communications node of mobile communication device location enablement system 10 (or multiple nodes associated with different types of networks or network technologies).

Execution of operations of user interface module 26 by processor 11 may control communication of processor 11 with one or more of input device 36 and output device 34. For example, input device 36 may include one or more user-operable devices (e.g., keyboard, keypad, pointing device, microphone, imaging device, or other device) that may enable a user of mobile communication device location enablement system 10 to enter instructions, commands, or data to processor 11. Output device 34 may include one or more devices (e.g., display screen, display panel, printer, lamp, speaker, vibrator, or other device) that may be used to output information in a manner that may be perceived and understood by a user of mobile communication device location enablement system 10.

For example, execution of operations of input sub-module 28 may enable a user to enter information to initiate an STS. For example, execution of operations of input sub-module 28 may request (e.g., via output device 34) and receive (e.g., via input device 36) input information that identifies a target mobile communication device 12. For example, target mobile communication device 12 may include a cellular telephone (to be understood as including a smartphone), or other mobile communication device with wireless communication capability. Such identifying information may include, for example, a name of an owner of target mobile communication device 12, a telephone number of target mobile communication device 12, or other identifying information. Execution of operations of input sub-module 28 may request and receive identifying information or authorization credentials that enable access by the user to mobile communication device location enablement system 10 or authorize the user to request initiation of the STS.

Execution of operations of control sub-module 30, e.g., in response to a user command entered via input device 36 and execution of input sub-module 28, may enable the user to initiate an STS, e.g., when target mobile communication device 12 is to be located. Execution of operations of control sub-module 30 may include retrieving data from a mobile communication device database that is accessible via data storage 38. For example, the retrieved data may identify a mobile communication network 14 or an operator of a mobile communication network 14 through which communication with target mobile communication device 12 may be established. Execution of operations of control sub-module 30, e.g., in response to a user command entered via input device 36 and execution of input sub-module 28, may enable the user to terminate an STS, e.g., when target mobile communication device 12 has been located or when a search for target mobile communication device 12 has been called off. For example, execution of operations of control sub-module 30 may result in execution of one or more operations of network interface module 20 to communicate with target mobile communication device 12 via mobile communication network 14.

Processor 11 may be configured execute one or more operations of network interface module 20 to communicate with one or more target mobile communication devices 12 via mobile communication network communications link 21 and one or more mobile communication networks 14. Mobile communication network 14 may include a cellular network, or another network that enables communication with mobile communication devices. For example, mobile communication network 14 may be associated with a mobile communication network operator to which target mobile communication device 12 is currently connected. Details of the communication between processor 11 and mobile communication network 14 may depend on the type of technology under which mobile communication network 14, or target mobile communication device 12, operates.

Operations of network interface module 20 (e.g., executing on a node of mobile communication device location enablement system 10) may be configured to communicate with different target mobile communication devices 12 using one or more different mobile communication network technologies. Different interfaces with mobile communication network 14 may be accessed by mobile communication device location enablement system 10 via mobile communication network communications link 21, e.g., in order to execute different tasks or operations of network interface module 20. Mobile communication network communications link 21 for communication between processor 11 and mobile communication network 14 may be wired (e.g., via a landline telephone network) or wireless (e.g., via a mobile telephone connection such as a cellular connection).

For example, when communicating with target mobile communication device 12 via a mobile communication network 14 that includes second generation (2G) digital radio access network (RAN) cellular technology, network interface module 20 may communicate with a base station controller (BSC) that communicates with target mobile communication device 12 via a base transceiver station (BTS). Communication of network interface module 20 with the BSC may include communication with one or more of a mobile switching center and visitor location register (MSC/VLR) or a serving GPRS (general packet radio service) support node (SGSN). When communicating with target mobile communication device 12 via a mobile communication network 14 that includes third generation (3G) RAN cellular technology, network interface module 20 may communicate with a radio network controller (RNC) that communicates with target mobile communication device 12 via a Node B. Communication of network interface module 20 with the RNC may include communication with one or more of an MSC/VLR, standalone serving mobile location center (standalone SMLC or SAS), a gateway GPRS support node (GGSN), or an SGSN. When communicating with target mobile communication device 12 via a mobile communication network 14 that includes fourth generation (4G) RAN cellular technology, network interface module 20 may communicate with a mobile management entity (MME) that communicates with target mobile communication device 12 via an evolved Node B (eNode B). Communication of network interface module 20 with the MME may include communication with a gateway mobile location center and a location retrieval function (GMLC/LRF).

Operation of network interface module 20 may include execution of operations of one or both of STS sub-module 22 and of parameters sub-module 24.

Execution of operations of STS module 22 may initiate an STS. For example, execution of STS module 22 may cause target mobile communication device 12 to transmit STS radiofrequency (RF) signal 18. Alternatively or in addition, execution of STS module 22 may verify that target mobile communication device 12 is transmitting STS RF signal 18 as part of operation of target mobile communication device 12 and mobile communication network 14. Selection of a mobile communication network 14 via which to communicate with target mobile communication device 12 may be in accordance with information that is retrieved from a mobile communication device database or directory, e.g., that is accessible via communication of processor 11 with data storage 38.

Execution of operations of parameters module 24 may identify parameters of STS RF signal 18 that distinguish STS RF signal 18 from other signals that may be emitted by mobile communication devices that communicate via one or more mobile communication networks 14. For example, execution of operations of parameters module 24 may retrieve from mobile communication network 14 parameters for identifying STS RF signal 18. The required parameters for identifying STS RF signal 18 may depend on the technology that is utilized by mobile communication network 14 or by target mobile communication device 12. For example, parameters for identifying STS RF signal 18 may be extracted by communication with an operations support system (OSS), BSC, or RNC of mobile communication network 14 in the form of a cellular network.

For example, an STS RF signal 18 may be transmitted by a target mobile communication device 12 that is operating under 2G technology. In this case, a frequency of the STS RF signal 18 may be identified by its absolute radio-frequency channel number (ARFCN), which may be interpreted to yield the frequency of STS RF signal 18. Additional information that may be required to identify STS RF signal 18 may be a timeslot (TS), and, in some cases, a sub-timeslot. The parameters for identification of STS RF signal 18 may be stored in a memory of data storage 38.

Processor 11 of mobile communication device location enablement system 10 (e.g., a processing unit on which operations of network interface module 20 are executed) may transmit parameters to identify STS RF signal 18 to one or more direction finder devices 16 via direction finder device communications link 27. For example, direction finder device communications link 27 for enabling processor 11 to communicate with direction finder devices 16 may include a direct or indirect (e.g., via satellite, drone, or other intermediate device) radio connection, optical connection, or other wireless connection (e.g., via a wireless network, mobile telephone network, or other network).

Each direction finder devices 16 may be configured to utilize the transmitted parameters to detect STS RF signal 18. For example, direction finder antenna 17 may be configured to receive signals over a range of radiofrequencies. Circuitry or a processor of direction finder device 16 is configured (e.g., with an appropriate digital filter, or otherwise) to distinguish STS RF signal 18 from other radiofrequency signals that are received by direction finder antenna 17.

Direction finder device 16 may be configured to determine a direction of target mobile communication device 12 (equivalent to the direction of origin of STS RF signal 18). For example, direction finder device 16 may be provided with a directional antenna or an interferometer to enable determining a direction toward target mobile communication device 12. Direction finder device 16 may incorporate one or more navigation devices, such as a Global Positioning System (GPS) receiver or similar device, to determine an absolute position (e.g., within less than 10 meters) of direction finder device 16. In some cases, e.g., where a transmission intensity of STS RF signal 18 is known, direction finder device 16 may be configured to estimate a distance to target mobile communication device 12. In some cases, two or more direction finder devices 16 that operate concurrently and in tandem may enable determining a location of target mobile communication device 12 by application of triangulation or a similar technique. In some cases, comparison of detected STS RF signal 18 with signals that are transmitted by one or more other cellular (or other) devices at known positions may enable determining a position of target mobile communication device 12. In some cases, a position of target mobile communication device 12 may be determined after detection of STS RF signal 18 by one or more direction finder devices 16 from two or more distinct positions (e.g., after movement of each direction finder device 16).

In some cases, one or more direction finder devices 16 are configured to calculate a position of target mobile communication device 12 and transmit the position information to mobile communication device location enablement system 10 (e.g., a processing unit of processor 11 on which operations of user interface module 26 are executed). In some cases, raw or partially processed data may be transmitted from direction finder device 16 to mobile communication device location enablement system 10. Execution of operations of position sub-module 32 may process the received data to determine a position of target mobile communication device 12.

A determined position of target mobile communication device 12 may be output to output device 34. For example, the determined position may be displayed on a map on a display screen of output device 34. Alternatively or in addition, the position may be otherwise output. A user of mobile communication device location enablement system 10 may report the output position of target mobile communication device 12 to appropriate rescue, assistance, or law enforcement personnel (e.g., to an emergency operator or dispatcher). Alternatively or in addition, mobile communication device location enablement system 10 may be configured to report the determined position directly (e.g., via a suitable communications channel) to an appropriate rescue, assistance, or law enforcement agency.

In some cases, geographic information that is detected direction finder device 16 may be utilized by personnel (e.g., a field team of one or more search, rescue, assistance, law enforcement, or other personnel) who are operating or are associated with direction finder device 16. Such information may include one or more of RSSI, a heat map, a bearing to target mobile communication device 12, or other information that may be interpreted to assist in determining a position of target mobile communication device 12 relative to direction finder device 16. The information may be interpreted by the personnel and used in their efforts to home in on and move toward target mobile communication device 12.

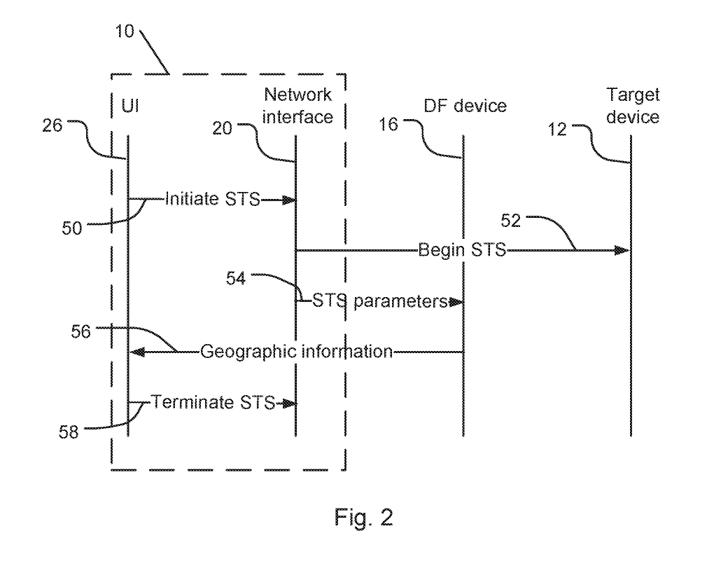

FIG. 2 is a diagram of an example of data flow during operation of a system to enable last mile positioning of a mobile communication device, in accordance with an embodiment of the present invention. In particular, FIG. 2 illustrates some data flow between user interface module 26 and network interface module 20 of mobile communication device location enablement system 10, and between with one another, and with direction finder (DF) device 16 and with target mobile communication device 12. It should be understood that division of the data flow into separate indicated data flows has been selected for convenience only, and equivalent alternate division into data flows is possible. Similarly, the order of the various indicated data flows has been selected for convenience and the different indicated data flows may, unless indicated otherwise, equivalently occur in a different order or concurrently.

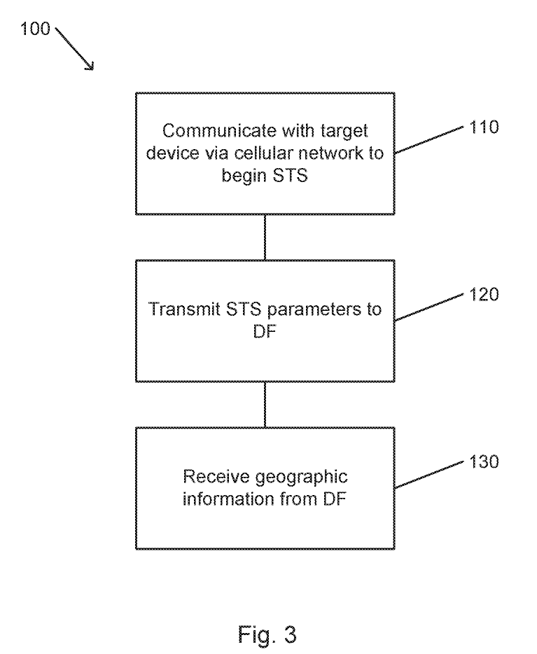

FIG. 3 is a flowchart depicting a method for last mile positioning of a mobile communication device, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Mobile communication device location method 100 may be executed by a processor 11 of a mobile communication device location enablement system 10. Execution of mobile communication device location method 100 may be initiated by a user of mobile communication device location enablement system 10 (e.g., operating input device 36). In some cases, processor 11 may be configured to automatically execute mobile communication device location method 100, e.g., in response to a predefined event.

Typically, a user of mobile communication device location enablement system 10 will initiate execution of mobile communication device location method 100 upon receiving identification of a target mobile communication device 12 whose position is to be determined. For example, a telephone number or other identifying information (e.g., a mobile communication network operator that operates mobile communication network 14 to which target mobile communication device 12 is connected) regarding target mobile communication device 12 may be known, or may be retrievable from a directory or database of mobile communication devices.

A user may cause a processing unit on which user interface module 26 is executed (e.g., a command, control and communications center of mobile communication device location enablement system 10) to send an STS initiation command 50 to a processing unit on which network interface module 20 is executed (e.g., a node of mobile communication device location enablement system 10).

In response processor 11 may communicate with target mobile communication device 12 via mobile communication network 14 to begin transmitting an STS signal (block 110).

The begin STS data flow 52 may include communication from mobile communication device location enablement system 10 to target mobile communication device 12 to begin transmitting STS RF signal 18. An acknowledgement of the command may be received by mobile communication device location enablement system 10 from mobile communication network 14. Further communication may include a request from mobile communication device location enablement system 10 to mobile communication network 14 to return parameters for detection and identification of STS RF signal 18. The requested parameters may be received from mobile communication network 14. In some cases, parameters may be obtained otherwise.

Parameters of STS RF signal 18 may be transmitted to one or more direction finder devices 16 (block 120 and STS parameters data flow 54). For example, direction finder devices 16 may be operated by one or more field teams. Direction finder devices 16 may then detect STS RF signal 18 to determine a position of target mobile communication device 12.

Geographic information related to last mile positioning of target mobile communication device 12 (e.g., a position of direction finder device 16, a direction toward or a distance to target mobile communication device 12 relative from direction finder device 16, a position of target mobile communication device 12, or data that may be processed to assist in homing in on or otherwise related to a position of target mobile communication device 12) may be received from direction finder devices 16 (block 130 and geographic information data flow 56). The resulting position data may be displayed as coordinates or on a map, or otherwise conveyed to a user of mobile communication device location enablement system 10, or to personnel (e.g., rescue, assistance, or law enforcement personnel) that require the position of target mobile communication device 12.

Once a last mile positioning of target mobile communication device 12 has been achieved (e.g., by visual or other physical contact with target mobile communication device 12, or by determination of a position of target mobile communication device 12), or in other circumstances (e.g., a position of target mobile communication device 12 is no longer required) transmission of STS RF signal 18 may no longer be required. A user may cause a processing unit on which user interface module 26 is executed to send an STS termination command 58 to a processing unit on which network interface module 20 is executed. Mobile communication device location enablement system 10 may then communicate with target mobile communication device 12 via mobile communication network 14 to cause target mobile communication device 12 to stop transmission of STS RF signal 18.

In some cases, a record of information related to execution of mobile communication device location method 100, or of parameters or data related to execution of mobile communication device location method 100, may be stored (e.g., on data storage 38) or reported. Such information may include, for example, an identification of target mobile communication device 12, parameters of a STS RF signal 18 (e.g., for later statistical or other analysis), description of a time frame of execution of mobile communication device location method 100 (e.g., start time, termination time, time to determine the position of target mobile communication device 12), billing-related information, or other information related to execution of mobile communication device location method 100.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for enabling last mile positioning of a target mobile communication device that is configured to communicate via a mobile communication network, the method comprising:
communicating with the target mobile communication device via the mobile communication network to cause the target mobile communication device to transmit a signal; and
sending at ne parameter of the transmitted signal to one or a plurality of direction finder devices to enable said one or a plurality of direction finder devices to receive and distinguish the transmitted signal.

2. The method of claim 1, further comprising receiving an identification of the target mobile communication device.

3. The method of claim 1, further comprising receiving said at least one parameter from the mobile communication network.

4. The method of claim 3, wherein receiving said at least one parameter comprises communicating with an operations support system (OSS), base station controller (BSC), or radio network controller (RNC) of the mobile communication network, the mobile communication network being a cellular network.

5. The method of claim 1, wherein the target mobile communication device comprises a cellular telephone, and wherein the mobile communication network comprises a cellular network.

6. The method of claim 1, wherein said at least one parameter is selected from the group of parameters consisting of frequency, timeslot and sub-timeslot.

7. The method of claim 1, further comprising receiving from said one or a plurality of direction finder devices geographic information related to the last mile positioning of the target bile communication device.

8. The method of claim 7, wherein the geographic information is selected from a group consisting of a position of a direction finder device of said one or a plurality of direction finder devices, a direction toward the target mobile communication device from a direction finder device of said one or a plurality of direction finder devices, a distance of the target mobile communication device from a direction finder device of said one or a plurality of direction finder devices, and a position of the target mobile communication device.

9. The method of any of claim 8, further comprising outputting a posit on of the target mobile communication device or of a direction finder device of said one or a plurality of direction finder devices.

10. The method of claim 1, further comprising receiving a command to communicate with the target mobile communication device to cause the target mobile communication device to begin the transmitting of the signal or to terminate the transmitting of the signal.

11. A system for enabling last mile positioning of a target mobile communication device that is configured to communicate via a mobile communication network, the system comprising:
a network communications link to the mobile communication network;
a finder communications link to one or a plurality of direction finder devices, each of said one or a plurality of direction finder devices configured to receive a signal and to generate information to enable last mile positioning of a source of the received signal; and
a processor that is configured to operate in accordance with programmed instructions to:
communicate with the target mobile communication device via the network communications link and the mobile communication network to cause the target mobile communication device to transmit a signal that is receivable by said one or a plurality of direction finder devices; and
send via the finder communications link at least one parameter of the transmitted signal to said one or a plurality of direction finder devices to enable said one or a plurality of direction finder devices to receive and distinguish the transmitted signal.

12. The system of claim 11, wherein the processor is further configured to communicate with an input device to receive an identification of the target mobile communication device.

13. The system of claim 11, wherein the processor is further configured to receive said at least one parameter from the mobile communication network,

14. The system of claim 11, wherein the processor is further configured to communicate with an input device to receive a command to communicate with the target mobile communication device to cause the target mobile communication device to begin the transmitting of the signal or to terminate the transmitting of the signal.

15. The system of claim 11, wherein the processor is further configured to communicate with the mobile communication network via the network communications link to receive said at least one parameter,

16. The system of claim 15, wherein the processor is configured to communicate with an OSS, BSC or RNC of the mobile communication network to receive said at least one parameter.

17. The system of claim 11, wherein the target mobile communication. device comprises a cellular telephone, and wherein the mobile communication network comprises a cellular network.

18. The system of claim 11, wherein said at least one parameter is selected from the group of parameters consisting of frequency, timeslot and sub-timeslot.

19. The system of claim 11, wherein the processor is further configured to receive from said one or a plurality of direction finder devices geographic information that is generated by said one or a plurality of direction finder devices.

20. The system of claim 19, wherein the geographic information is selected from a group consisting of a position of a direction finder device of said one or a plurality of direction finder devices, a direction toward the target mobile communication device from a direction finder device of said one or a plurality of direction finder devices, a distance of the target mobile communication device from a direction finder device of said one or a plurality of direction finder devices, and a position of the target mobile communication device.
